(19) United States
(12) Patent Application Publication
(10) Pub. No.: US 2014/0053737 A1
(43) Pub. Date: Feb. 27, 2014

(54) BEVERAGE INFUSER

(71) Applicants: Larissa Simontov, Seattle, WA (US); Slava Simontov, Seattle, WA (US)

(72) Inventors: Larissa Simontov, Seattle, WA (US); Slava Simontov, Seattle, WA (US)

(21) Appl. No.: 14/031,222

(22) Filed: Sep. 19, 2013

Related U.S. Application Data
(63) Continuation-in-part of application No. 13/592,341, filed on Aug. 23, 2012.
Application No. 13/592,341 is a continuation of application No. 29/459,119, filed on Jun. 26, 2013.

(51) Int. Cl. A47J 31/06

(52) U.S. Cl. CPC A47J 31/0636
USPC 99/323

(57) ABSTRACT

A single serving beverage infuser and method of pretreating the same is disclosed herein. In one embodiment, the beverage infuser comprises a receptacle pattern sheet foldable into a receptacle for receiving a charge of beverage infusing material, two permeable regions through which liquid is permitted to freely flow between the regions lying inside and outside of the receptacle, two interlocking regions for maintaining the receptacle pattern sheet in the folded configuration, and two support hangers for securing the receptacle, when the receptacle pattern sheet is folded into a receptacle, onto the rim of a beverage container. Preferably, the infuser is made from wood veneer due as it is a renewable and biodegradable resource.

### CROSS-REFERENCE TO RELATED APPLICATIONS

This application is a continuation-in-part of application Ser. No. 13/592,341 filed Aug. 23, 2012, entitled “Single Serving Beverage Infuser and Method of Pretreating The Same,” (attorney docket number SIMO-1-1001), and is also a continuation of U.S. Ser. No. 29/459,119 filed Jun. 26, 2013, entitled “Tea Infuser,” (attorney docket number SIMO-2-1001). The foregoing applications are incorporated herein by reference in their entirety as if fully set forth herein.

### FIELD

The present disclosure relates generally to the field of infusing beverages and, more particularly, to a beverage infuser which may be folded out of a flat material and preferably a wood veneer.

### BACKGROUND

In recent years, there has been an increase in the interest in and consumption of infused beverages, such as teas, in the United States. There has also been an increased demand for means of producing single servings of infused beverages. Generally, a single serving of an infused beverage is produced by utilizing at least one type of strainer or standard disposable tea bag.

One type of strainer that is commonly used for producing single servings of an infused beverage comprises a “well portion” for receiving a charge of infusing material, such as tea leaves, and is placed over the opening of a beverage container. In order to infuse the desired beverage the well portion is either submerged into hot water already in the beverage container or hot water is poured through the charge of infusing material and allowed to strain into the beverage container. Such strainers are commonly made from natural bamboo fibers, plastics, or from various metals. Typically, this type of strainer comprises a single handle and, therefore, while a beverage is being infused, a user must hold the strainer in such a position that the charge of infusing material remains in contact with the hot water. This type of strainer has the drawback of being relatively awkward and inefficient from a process standpoint. Many beverage consumers prefer to place the charge of infusing material in contact with the hot water without manually holding the strainer in this position; however, some types of strainers are ill-suited to perform this task.

The tea bag addresses certain disadvantages of the aforementioned straining equipment; nonetheless tea bags are not without disadvantages. A typical tea bag comprises a porous sealed bag containing a single charge of infusing material, e.g. crushed tea leaves. The porous sealed bag is commonly made of bleached paper, bleached cheese cloth, polylactic acid (PLA), or nylon fabrics derived from genetically modified corn. Due to the relatively small pore size of a typical tea bag, once the pores are saturated with water the resulting surface tension creates a barrier between the mediums of water and air. Initially, the surface tension seals an amount of air within the tea bag which causes the bag to float and slows the infusing process. Once the bag is submerged, the relatively small pore size causes an amount of drag and/or resistance on the fluid and prevents the free and open flow of water through the infusing medium, e.g. crushed tea leaves, which further slows the process. Beverage consumers often attempt to induce the flow of hot water through the charge of infusing material by repeating the steps of dunking the bag into the water, allowing the bag to become saturated, removing the bag from the water, and allowing the liquid to drain from the bag. Unfortunately, the surface tension effect which initially sealed air in the tea bag causing it to float now seals liquid in the tea bag and prevents it from draining. This again slows the process of infusing the beverage and, because many beverage consumers do not wish to wait for the bag to drain completely, an amount of infused liquid will be discarded with the tea bag resulting in excess waste of the tea product and excess dripping.

Due to the impeded flow of water through the tea bag material, it is typical for tea bags to contain tea fannings because without freely flowing water, the time required to infuse a beverage using higher quality tea leaves is undesirable. Fannings are small pieces of tea remaining after higher grade tea leaves have been gathered, and fannings with very small particles are known as tea dusts. It is these tea dusts that are most commonly used in tea bags. These low quality tea dusts quickly color the liquid being infused but fail to quickly transfer flavors into the beverage. Moreover, the quality of tea fannings and dusts quickly degrades resulting in tea bags having a reduced shelf life when compared to higher quality teas. Therefore, a single serving beverage infuser that allows for water to freely flow through the infuser when submerged and quickly drains water therefrom when removed from the water is desirable.

Other disadvantages of the tea bag include that it typically must be discarded after only a single use and that it is available in only limited pre-manufactured flavors. Many infused beverage drinkers are deeply conscious of environmental and health issues and, as such, prefer to use products that are fully biodegradable and not harmful to the body. However, recent evidence suggests that certain chemicals are likely leaching out of plastic tea bags when heated above the material's “glass transition” temperature (T_{g}). For example, single use polyethylene terephthalate (PET) water bottles have been found to have estrogen-mimicking pollutatnts which have been linked to cancer. Because many tea bags are made of PET it is likely the case that such pollutants are leaching into tea, especially when heated to or above T_{g} during the steeping process. Even paper tea bags are not free from harsh chemicals which may pose health risks. For example, U.S. Pat. No. 5,431,997 A discloses a porous web material suitable for use in tea bags which is treated with an aqueous emulsion of a hydrophobic agent wherein some of the disclosed hydrophobic agents, e.g. fluorohydrocarbons, can have profound health effects when ingested.

### SUMMARY

A beverage infuser is disclosed herein. In one embodiment, the beverage infuser comprises a receptacle pattern sheet foldable into a receptacle for receiving a charge of beverage infusing material, two permeable regions through which liquid is permitted to freely flow between the regions lying inside and outside of the receptacle, two interlocking regions for maintaining the receptacle pattern sheet in the folded configuration, and two support hangers for securing the receptacle, when the receptacle pattern sheet is folded into a receptacle, onto the rim of a beverage container. Preferably, the infuser is made from wood veneer due as it is a renewable and biodegradable resource. Moreover, wood veneer will not leach harmful chemicals into a beverage during the steeping process as currently marketed products likely due.

### BRIEF DESCRIPTION OF THE DRAWINGS

Embodiments of the beverage infuser are described in detail below with reference to the following drawings.

FIG. 1 is a perspective view of the Beverage Infuser, in accordance with a first embodiment, showing an exemplary environment in which the Beverage Infuser may be used, namely affixed to rim of a beverage mug (shown in broken lines);

FIG. 2 is a front view of the Beverage Infuser in accordance with the first embodiment;

FIG. 3 is a right view of the Beverage Infuser in accordance with the first embodiment;

FIG. 4 is a left view of the Beverage Infuser in accordance with the first embodiment;

FIG. 5 is a top view of the Beverage Infuser in accordance with the first embodiment;

FIG. 6 is a rear view of the Beverage Infuser in accordance with the first embodiment;

FIG. 7 is a rear view thereof showing the Beverage Infuser in a partially unfolded manner such that the rear is unclasped;

FIG. 8 is a front view thereof showing the flat pattern of the Tea Infuser; and

FIG. 9 is a right view of the Beverage Infuser in accordance with a second embodiment.

### DETAILED DESCRIPTION

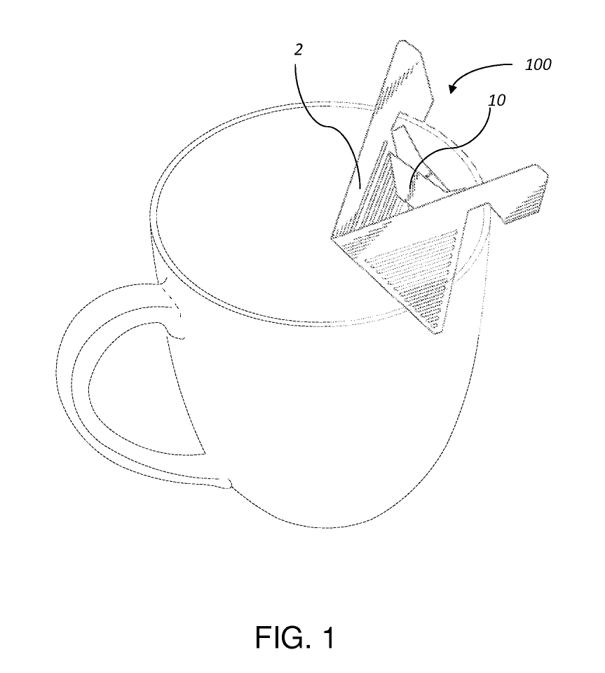

A beverage infuser is disclosed herein where specific details of certain embodiments of the beverage infuser are set forth in the following description and in FIGS. 1-9 to provide a thorough understanding of such embodiments. The beverage infuser disclosed herein may have additional embodiments, may be practiced without one or more of the details described for any particular described embodiment, or may have any detail described for one particular embodiment practiced with any other detail described for another embodiment.

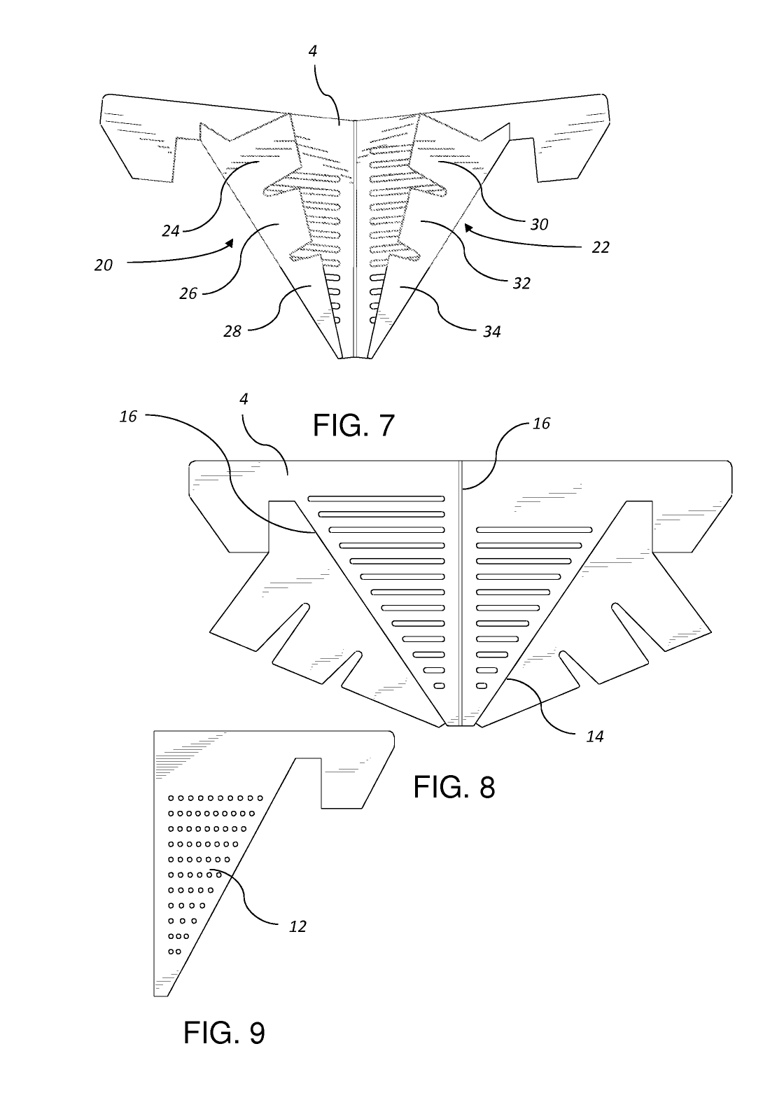

FIG. 1 is a perspective view, in accordance with a first embodiment of the Beverage Infuser 100, showing the beverage infuser 100 in a self-supporting position in an exemplary environment in which the Beverage Infuser 100 may be used, namely affixed to rim of a beverage mug (shown in broken lines). In certain embodiments, the beverage infuser 100 comprises a receptacle 2 formed by a folded receptacle pattern sheet 4 (shown in a partially unfolded position in FIG. 7 and as a flat pattern in FIG. 8). The receptacle 2 is intended to receive a charge of beverage infusing material, e.g. loose tea leaves. As can be discerned from the figures, in the illustrated first embodiment, a charge of beverage infusing material is to be inserted through an opening 10 at a top end.

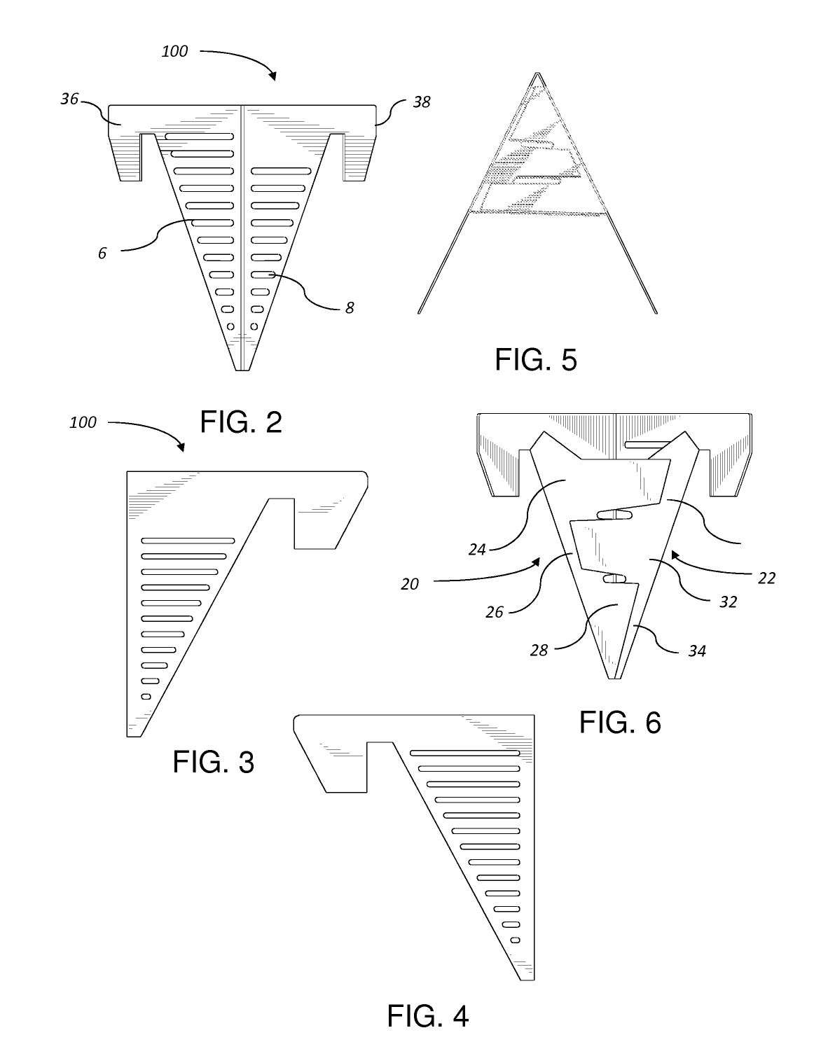

Referring now to FIGS. 2 - 4, in the illustrated embodiment, the beverage infuser 100 and, more particularly the receptacle 2, further comprises two permeable regions, 6 and 8, through which liquid is permitted to freely flow between the regions lying inside and outside of the receptacle 2. In the embodiment of FIGS. 1-8, it can be seen that the permeable regions 6, 8 are comprised of a plurality of openings each of which correspond generally to the width of the receptacle 2 at the relevant point. Referring briefly to FIG. 9, an alternate embodiment is shown wherein a permeable region 12 shown comprises a series of small round openings as opposed to the longer slit like openings of the first embodiment. The aforementioned geometries suitable for constructing a permeable region are for illustrating purposes only and are not intended to limit the scope of the beverage infuser. Thus, any geometry which comprises a suitable pore size is suitable and within the scope of the meaning of permeable region. Preferably, the size of the pores on the receptacle are sufficiently small in size that a charge of beverage infusing material, e.g. crushed loose leaf tea leaves, cannot escape from the receptacle 2 through the pores but also sufficiently large that any surface tension formed on the receptacle has a negligible effect on the flow of water.

In some embodiments, the receptacle pattern sheet 4 further comprises one or more predefined fold lines 14, 16, and 18 configured to assist in the accurate folding of the receptacle pattern sheet 4 into the receptacle 2 shape. Preferably, the predefined fold lines are not merely visible indicators of where to create a fold but rather comprise some type of geometrical feature(s) increasing the probability a fold will occur precisely at the location of a predefined fold line. For example, a predefined fold line may comprise a scored region, a perforated region, an indented region, or any combination of those various geometries. Moreover, it has been found that using a laser to both cut the receptacle pattern sheet 4 from a piece of stock material and to score the predefined fold lines 14, 16, 18, provides accurate and repeatable results. Due to the advancement in laser cutting and scoring technology, especially in conjunction with the proliferation and newfound affordability of computer numerical control (CNC) technology, lasers can potentially provide even more accurate cutting and scoring results than a corresponding mechanical operation. Laser technology is, of course, not limited to cutting and scoring but can also be utilized for a variety of other operations including perforating materials.

In some embodiments, the beverage infuser 100 further comprises one or more interlocking regions 20, 22 which are configured for maintaining the receptacle pattern sheet 4 in a folded position thereby maintaining the shape of the receptacle 2. In the illustrated embodiment, the interlocking regions 20 and 22 are each comprised of an array of adjacent fingers 24, 26, 28, 30, 32, and 34 (labeled in FIG. 7). The fingers of each interlocking region are configured to interlock with the fingers of the opposing region. For example, FIG. 6 illustrates that fingers 24, 26, and 28 of interlocking region 20 are configured to mate with fingers 30, 32, and 34 of interlocking region 22 by placing finger 24 over (under) finger 30, finger 26 under (over) finger 32, and finger 28 over (under) finger 34. In the preferred embodiment, which is made wholly from wood veneer, the roughness of the wood veneer surface of the receptacle pattern sheet 4 creates sufficient frictional forces to maintain the receptacle pattern sheet 4 in the folded position. In different embodiments, the interlocking region does not include fingers and may, for example, include one or more hooks on one interlocking region and one or more slits or opening on the opposing interlocking region for the aforementioned hooks to clasp through.

In some embodiments, the beverage infuser further comprises two support hangers 36 and 38 configured for suspending the receptacle 2. It is an object of the beverage infuser 100 disclosed herein to be configured for supporting itself within a beverage container as shown in FIG. 1. Of course, the geometry of support hangers 36 and 38 in the illustrated embodiment is intended for illustrative purposes only and is not intended to limit the scope of the beverage infuser as disclosed.

It is preferable that the single serving beverage infuser comprises a natural and biodegradable material such that it is readily disposable, e.g. it can be placed in standard garbage or composted. Moreover, it is intended for the single serving beverage infuser to be reusable if the user so desires. It has been found that wood veneer is an ideal material to achieve these properties; however, other materials obviously may be chosen. White Birch wood veneer and Aspen wood veneer are two highly preferable choices.

While preferred and alternate embodiments have been illustrated and described, as noted above, many changes can be made without departing from the spirit and scope of the beverage infuser. Accordingly, the scope of the beverage infuser is not limited by the disclosure of these preferred and alternate embodiments. Instead, the scope of the beverage infuser should be determined entirely by reference to the claims that follow.

What is claimed is:

1. An infuser for making beverages comprising:
a receptacle pattern sheet foldable into a receptacle for receiving a charge of beverage infusing material; and
at least one permeable region through which liquid is permitted to freely flow between the regions lying inside and outside of the receptacle.

2. The infuser of claim 1, wherein the receptacle pattern sheet comprises at least one predefined fold line.

3. The infuser of claim 2, wherein the at least one predefined fold line comprises a least one of: a perforated region; a scored region; an indented region; or any combination thereof.

4. The infuser of claim 1, wherein when the receptacle pattern sheet is folded into a receptacle for receiving a charge of beverage infusing material, the receptacle comprises an at least partially open top end and a closed bottom end such that the receptacle is configured for receiving the charge of beverage infusing material through the at least partially open top end.

5. The infuser of claim 1, wherein the receptacle pattern sheet further comprises at least one interlocking region configured for maintaining the receptacle pattern sheet in a folded configuration.

6. The infuser of claim 5, wherein the receptacle pattern sheet comprises two interlocking regions, each of the two interlocking regions comprising an array of at least two generally adjacent fingers configured for interlocking with the array comprised within the opposite interlocking region.

7. The infuser of claim 1, further comprising at least one support hanger for securing the receptacle, when the receptacle pattern sheet is folded into a receptacle, onto the rim of a beverage container.

8. The infuser of claim 7, wherein the infuser comprises two support hangers each flatly extending from a single side of the receptacle.

9. The infuser of claim 1, wherein the receptacle pattern sheet is comprised of a wood veneer.

10. The infuser of claim 9, wherein the wood veneer is chosen from the group consisting of: Aspen, Birch.

11. The infuser of claim 9, wherein the receptacle pattern sheet comprises at least one predefined fold line, and wherein each of the at least one fold lines is oriented within roughly forty-five degrees from perpendicular to a grain direction of the wood veneer.
